(19) United States
(12) Patent Application Publication
(10) Pub. No.: US 2010/0186872 A1
(43) Pub. Date: Jul. 29, 2010

(54) METHOD FOR LAYING DOWN AT LEAST AN ELASTIC ELEMENT IN A PROCESS FOR PRODUCING TYRES FOR VEHICLES, PROCESS FOR PRODUCING TYRES FOR VEHICLES AND APPARATUS FOR CARRYING OUT SAID LAYING DOWN METHOD

(75) Inventors: Pietro Dale', Milano (IT); Alessandro Vergani, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI TYRES S.p.A., Milano (IT)

(21) Appl. No.: 12/450,964

(22) PCT Filed: Apr. 23, 2007
(86) PCT No.: PCT/IB2007/001059

§ 371 Date: Mar. 3, 2010

(51) Int. Cl. B29D 30/30; B29D 30/00

(52) U.S. Cl. 156/64; 156/110.1; 156/128.1; 156/361

(57) ABSTRACT

A method of laying down at least one elastic element in a process for producing tyres for vehicles includes the following steps: determining a first parameter representative of a laying speed at which at least one elastic element is laid down around a tyre forming drum; determining a second parameter representative of a percent elongation to be applied to the elastic element; adjusting, as a function of the first and second parameters, a rotation speed of a control roller positioned upstream of the forming drum and having a radially external surface at least partly in engagement with the elastic element for controlling the laying profile of the at least one elastic element. A process for producing tyres for vehicles and an apparatus for carrying out the laying method are also described.

The present invention in a first aspect relates to a method of laying down at least one elastic element in a process for producing tyres for vehicles.

The invention in a different aspect also relates to a process for producing tyres for vehicles and, in a further aspect, relates to an apparatus for laying down at least one elastic element in a process for producing tyres for vehicles.

Herein and in the following of the present specification and the appended claims, by laying profile of an elastic element it is intended the tension of said elastic element as a function of time during application of said elastic element onto a forming drum.

In addition, by “elastic element” it is intended a continuous thread element having at least one cord (assembly of one or more filament-like elements or strands) of textile or metallic material covered with elastomeric material.

A tyre for vehicles generally comprises a carcass structure provided with at least one carcass ply having respectively opposite end flaps in engagement with respective annular anchoring structures, integrated into the regions usually identified with the name of “beads”, showing an inner diameter substantially corresponding to a so-called “fitting diameter” of the tyre onto a respective mounting rim.

Associated with the carcass structure is a belt structure comprising one or more belt layers, located in radial superposed relationship with respect to each other and to the carcass ply.

Each belt layer can have textile or metallic reinforcing cords with a crossed orientation and/or substantially parallel to the circumferential extension direction of the tyre (zero-degree layer).

Applied at a radially external position to the belt structure is a tread band, also of elastomeric material like other semi-finished products constituting the tyre.

Respective sidewalls of elastomeric material are further applied at an axially external position, to the side surfaces of the carcass structure, each extending from one of the side edges of the tread band until close to the respective annular anchoring structure to the beads.

In tyres of the tubeless type, an airtight coating layer, usually referred to as “liner” covers the inner surfaces of the tyre.

The carcass structure and belt structure are generally made separately of each other in respective work stations, to be mutually assembled at a later time.

In more detail, manufacture of the carcass structure first contemplates application of the carcass ply or plies onto a building drum, to form a so-called “carcass sleeve” of substantially cylindrical shape.

The annular anchoring structures to the beads are formed on the opposite end flaps of the carcass ply that are subsequently turned up around the annular structures themselves so as to enclose them in a sort of loop.

A so-called “outer sleeve” is made on a second or auxiliary drum, which outer sleeve comprises the belt layers applied in mutually radially superposed relationship, and optionally the tread band applied to the belt layers at a radially external position.

As described above, the outer sleeve can further comprise a zero-degree belt layer that is obtained by means of said elastic element.

More specifically, to make the zero-degree belt layer, the elastic element is wound up on the auxiliary drum in the form of circumferential coils suitably distributed in an axial direction; due to the conformation of the auxiliary drum, this belt layer is given the desired geometric profile. Correct maintenance of the geometric features of this profile is indispensable for proper working of the whole tyre.

The outer sleeve is then picked up from the auxiliary drum to be coupled to the carcass sleeve.

US 2003/0213863 discloses a method and an apparatus for applying a cord onto a drum driven in rotation during manufacture of articles reinforced by cords, such as tyres for example. In more detail, the described method and apparatus enable instantaneous measurement of the properties of the cord while the latter is being supplied to the drum.

A magnitude of specific interest appears to be the length of the cord that is wound on the drum; for this reason, the described structure is mainly intended for calculation of the “effective pitch line differential (EPLD)”, i.e. the radial distance between the drum surface and the neutral bending plane of the cord wound up on the drum itself.

To carry out this measurement, the apparatus described in US 2003/0213863 has a plurality of capstans and transmission rollers guiding the cord from the roller on which it is firstly wound, to the drum. In more detail, the path of travel of the cord is divided into three sections, in each of which the cord has a different tension.

A first section is defined between the drum and a first capstan; a second section is defined between the first capstan and a second capstan; a third section is defined between the second capstan and the roller on which the cord is firstly wound. The second capstan is a device for control of the cord tension through which tension between the third and second section of the path of travel is varied.

Tension variation from the third to the second section takes place when, during operation of the apparatus, the cord speed in the second section is variable; this variable speed of the cord is determined by the speed required for the cord by the first capstan (the closest to the drum on which the cord is to be wound).

The cord tension in the second section is measured by a tension sensor, through which the speed of the second capstan relative to the speed of the first capstan is controlled, to compensate for each variation in the length of the second section and maintain tension in the second section to a desired value.

The control system of the motor driving the second capstan in rotation can use, as feedback, the tension supplied by said tension sensor as well as position and rotation data coming from an encoder associated with the first capstan.

The first capstan is disposed is such a manner as to enable control of the length of the cord that is supplied to the drum, rather than the cord tension.

Tension of the cord wound on the drum is controlled through a radially expandable diaphragm mounted on the radially external surface of the drum itself.

Rotation of the drum and the first capstan is measured by respective encoders; a control system adjusts the rotation speed and angular acceleration of said drum and said first capstan, so that they are moved relative to each other according to a predetermined algorithm.

The Applicant has verified that an apparatus of the type disclosed in US 2003/0213863 does not allow a laying profile of an elastic element on a forming drum to be followed in a precise manner according to the design specifications, for instance during the transients of a winding step of said elastic element or concurrently with unexpected events upstream of the laying region of the elastic element itself.

Since the state of tension in the cord or cords included in the elastic element is critical for maintaining the planned tyre performance, the Applicant has found the possibility of controlling said laying profile of an elastic element, in particular during formation of a zero-degree layer in the manufacture of a belt structure.

Therefore, in accordance with the present invention, the Applicant has faced up to the problem of controlling the tension that an elastic element, necessary for formation of a tyre component under processing, has at a surface thereof to be laid down on a forming drum for manufacture of said component.

In accordance with the present invention, the Applicant has found that, by adjusting the rotation speed of a control roller on which the elastic element is engaged, as a function of the rotation speed of the forming drum and the percent elongation to be imparted to the elastic element itself, it is possible to control the laying profile of the elastic element in a very precise and reliable manner, in strict observance of the design specifications.

More particularly, in a first aspect the present invention relates to a method of laying down at least one elastic element in a process for producing tyres for vehicles, said method comprising the following steps:
determining a first parameter representative of a laying speed at which at least one elastic element is laid down around a tyre forming drum;
determining a second parameter representative of a percent elongation to be applied to said elastic element;
adjusting as a function of said first and second parameters, a rotation speed of a control roller positioned upstream of said forming drum and having a radially external surface at least partly in engagement with said elastic element, to control the laying profile of said at least one elastic element.

The Applicant has verified that taking into consideration both the rotation speed of the forming drum and the percent elongation to be imparted to the elastic element before winding up of the latter on said drum, the elastic element is given the desired tension instant by instant.

Advantageously, accuracy of the tension values in time during laying of the elastic element is also maintained if the tyre production process is carried out at different laying speeds.

Accuracy in the tension control of the elastic element is also advantageously maintained during the starting and final transients of the rotation movements of the forming drum.

More specifically, the Applicant has verified that the method of the invention allows the difference between the theoretical laying profile and real laying profile of an elastic element on a forming drum to be minimised, in particular in the starting and/or final transients.

The Applicant has in fact ascertained that the equations describing the behaviour of an elastic body under static conditions (i.e. when the elastic body itself is stationary), can remain valid under dynamic conditions too, provided the characteristic motion parameters of the body are taken into consideration in a suitable manner.

Under dynamic conditions, the elastic element to be laid down on the auxiliary drum is not stationary, but it goes on sliding and “renewing” during transfer from the feeding roller on which it is firstly wound to the forming drum;

By introducing said powered roller between the feeding roller and auxiliary drum, tension of the elastic element on the laying surface is adjusted instant by instant.

The Applicant has therefore verified that it is possible to adjust the tension of the elastic element by modifying the percent elongation of said element instant by instant, through suitable adjustment of the relative speeds of the forming drum and the control roller.

In a further aspect, the present invention relates to a process for producing tyres for vehicles, comprising the following steps:
manufacturing a carcass structure;
associating said carcass structure with a belt structure;
associating a tread band with said belt structure, at a radially external position;
   wherein any of said steps comprises:
laying down at least one elastic element at a position radially external to a forming drum by carrying out the following sub-steps:
determining a first parameter representative of a laying speed at which said at least one elastic element is laid down around said forming drum;
determining a second parameter representative of a percent elongation to be applied to said elastic element;
adjusting as a function of said first and second parameters, a rotation speed of a control roller positioned upstream of said forming drum and having a radially external surface at least partly in engagement with said elastic element to control the laying profile of said at least one elastic element.

In another aspect, the present invention relates to an apparatus for laying down at least one elastic element in a process for producing tyres for vehicles, said apparatus comprising:
a first processing module for determining a first parameter representative of a laying speed at which at least one elastic element is laid down around a forming drum;
a second processing module to determine a second parameter representative of a percent elongation to be applied to said elastic element;
a control roller positioned upstream of said forming drum and having a radially external surface at least partly in engagement with said elastic element;
an adjusting module operatively associated with said control roller for adjusting, as a function of said first and second parameters, a rotation speed of said control roller for controlling the laying profile of said at least one elastic element.

The present invention, in at least one of said aspects, can have one or more of the preferred features that are hereinafter described.

Preferably, the second parameter representative of the percent elongation to which the elastic element is to be submitted, is calculated as a function of a tension that is to be applied to the elastic element itself.

Preferably, the laying speed of the elastic element, that can be defined by the rotation speed of the forming drum, is detected in real time, to calculate the corresponding rotation speed of the control roller instant by instant.

In this way the system can be made still more precise and reliable, since the rotation speed of the control roller is determined as a function of the true rotation speed of the forming drum; in other words, the difference between the two rotation speeds which in turn determines the percent elongation and therefore the tension of the elastic element, is calculated starting from the real operation conditions of the system.

Preferably, the elastic element is laid down around the forming drum to make a zero-degree reinforcing layer of the belt structure.

In this instance, the operation of laying down the elastic element is referred to as “spiralling”, and the first parameter used in the control method is exactly representative of the so-called spiralling speed.

In this case, the forming drum can be an auxiliary drum, in a process in which the carcass structure and belt structure are made separately, on a main drum and an auxiliary drum respectively.

Advantageously, provision of a further feedback control is made possible on the elastic-element tension between the control roller and forming drum.

In particular, tension of the elastic element is detected downstream of the control roller; the detected tension is then compared with a pre-set value, representative of the tension to which the elastic element must be submitted at that given instant. Depending on the possible difference between the detected tension and the pre-set value, a further adjustment is carried out on the rotation speed of the control roller.

Further features and advantages will become more apparent from the detailed description of a preferred, but not exclusive, embodiment of a method of laying down at least one elastic element in a process for producing tyres for vehicles, a process for producing tyres for vehicles and an apparatus for carrying out said laying method, in accordance with the present invention.

This description will be set out hereinafter with reference to the accompanying drawings, given by way of non-limiting example, in which:

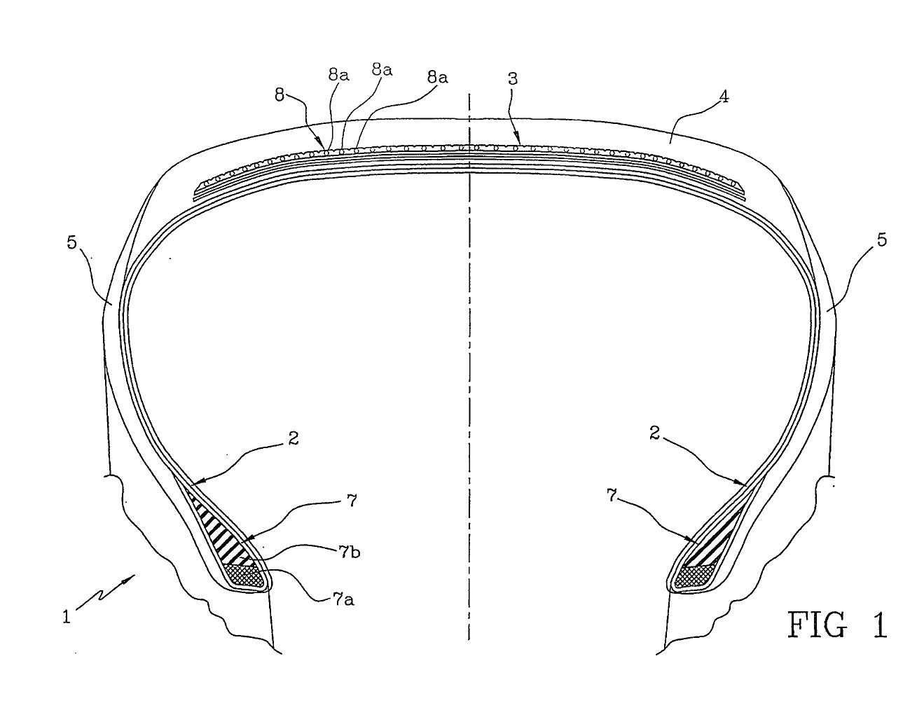

FIG. 1 shows a diametrical half-section of a tyre made in accordance with the production process of the invention;

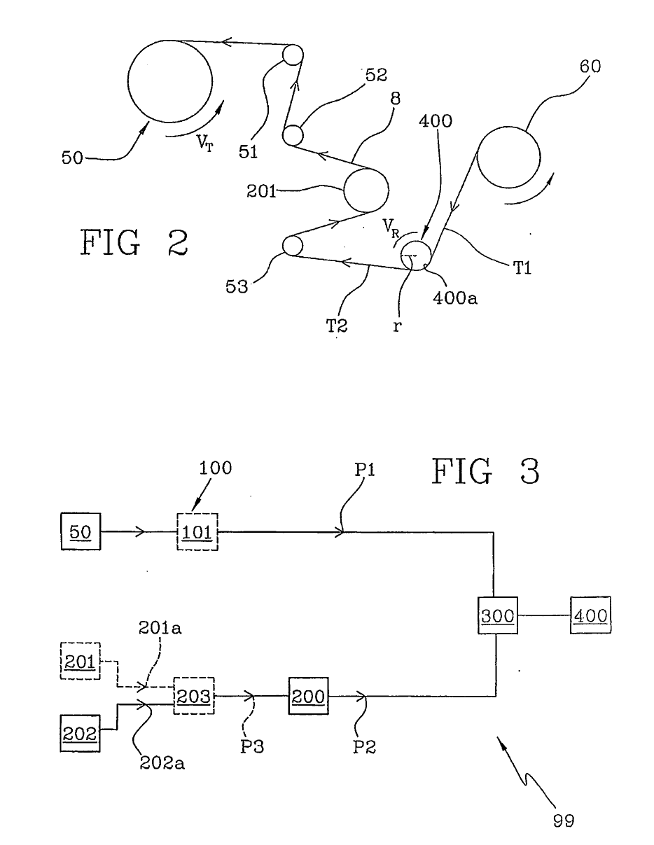

FIG. 2 diagrammatically shows a structure utilised for carrying out the control method in accordance with the invention;

FIG. 3 shows a block diagram of a control apparatus in accordance with the present invention;

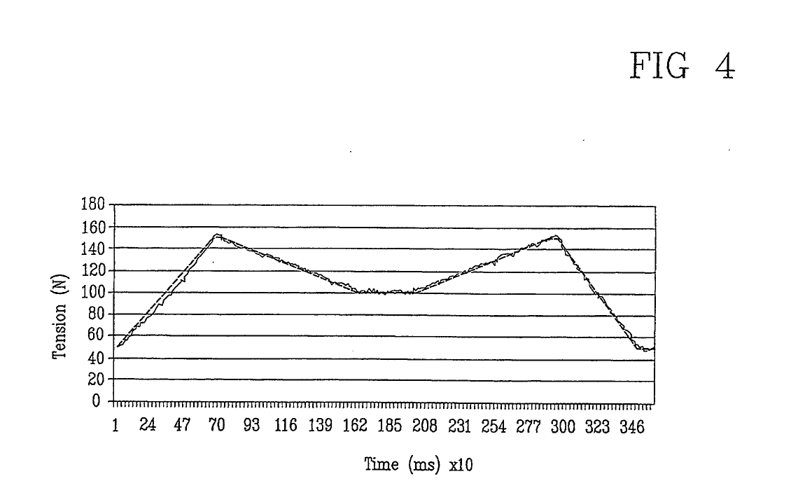

FIG. 4 shows a graph representative of a comparison between a theoretical time course and the corresponding practically-obtained time course of a laying profile of an elastic element during laying of same in accordance with the method of the invention.

With reference to the drawings, a generic tyre for the manufacture of which the control method and process in accordance with the invention can be utilised has been generally identified with 1.

For producing tyre 1 (FIG. 1), a carcass structure 2 and a belt structure 3 that are suitably associated with each other are generally provided. In addition, a tread band 4 is associated externally of said belt structure 3.

At the radially internal ends of the carcass structure 2 the so-called beads 7 are made, inside which at least one “bead core” 7a is provided, possibly associated with a filling insert 7b.

Applied to the side surfaces of the carcass structure 2 are sidewalls 5 of elastomeric material; each sidewall 5 extends from one of the side edges of the tread band 4 to a corresponding bead 7.

It will be recognised that the radially external end of each sidewall 5 can be, interposed between the edge of the tread band 4 and the carcass ply 6 (according to a configuration of the “underlying sidewalls” type); alternatively, the edge of the tread band 4 can be interposed between this radially external end of each sidewall 5 and the carcass ply 6 (according to a configuration of the “overlying sidewalls” type, diagrammatically shown in FIG. 1).

The carcass structure 2 and belt structure 3 can be made on distinct drums, referred to as main drum and auxiliary drum, respectively.

Assembling between the carcass structure 2 and belt structure 3 can take place directly on the main drum, or on a so-called “shaping drum”, on which the carcass structure 2 is placed, from the main drum, at the end of manufacture of said carcass structure 2.

Alternatively, tyre 1 can be manufactured on a single drum, by a technique according to which the different tyre elements are manufactured through laying of strip-like elements or elongated elements of elastomeric material, at a radially external position relative to a drum having a substantially toroidal conformation.

The alternative manufacturing technique briefly summarised hereinabove is described in patents EP 0928680 B1 and EP 0928702 B1 in the name of the same Applicant, for example.

The above described steps may each comprise a sub-step in which at least one elastic element 8 is laid down at a radially external position to a forming drum 50.

This forming drum 50 can be both the main drum and the auxiliary drum (in which case the carcass structure 2 and belt structure 3 are made on distinct drums), or the shaping drum on which carcass structure 2 and belt structure 3 are assembled, should this drum be used.

The forming drum 50 can also be the single drum used in the manufacturing technique described in the above mentioned patents EP 0928680 B1 and EP 0928702 B1.

Preferably, laying of the elastic element 8 is part of the step of making the belt structure 3; in particular, the elastic element 8 is laid down at a radially external position around said forming drum 50 in the so-called zero-degree spiralling step.

Preferably, the elastic element 8 comprises one or more nylon threads, externally covered with a layer of elastomeric material.

In a particular embodiment in accordance with the invention, the elastic element 8 is wound up around the forming drum 50 on the latter when at least two strips of the belt structure 3 of tyre 1 under processing have already been provided.

In fact, the elastic element 8 can comprise reinforcing cords 8a of the belt structure 3. These cords 8a are laid in an orientation substantially parallel to the circumferential extension direction of tyre 1.

In addition or alternatively, the elastic element 8 may comprise, by way of example only, filament-like elements used for making the so-called bead cores 7a, reinforcing inserts integrated into the beads 7, reinforcing inserts applied under the opposite edges of the belt structure 3 (consisting of one or more threads wound up around the rotation axis of the forming drum 50), and the like.

In more detail, the elastic element 8 is firstly wound up on a roller 60 (FIG. 2) and therefrom progressively unwound to be laid down around the forming drum 50.

Between roller 60 and forming drum 50 one or more transmission rollers 51, 52, 53 are provided to guide the elastic element 8 along a predetermined trajectory.

Shown in FIG. 2 are only three transmission rollers (denoted at 51, 52 and 53) by way of example; obviously, it is possible to use any number of transmission rollers or other equivalent elements, depending on the path to be followed by the elastic element 8.

A control roller 400 is positioned upstream of the forming drum 50; the control roller has a radially external surface 400a at least partly in engagement with the elastic element 8, so as to be able to adjust tension of same.

It is to be pointed out that a kinematic structure (not shown) can be provided between roller 60 and control roller 40, the function of which is to guide the elastic element 8 in its starting length.

For tension adjustment of the elastic element 8 between control roller 400 and forming drum 50, a first parameter P1 is determined that is representative of a laying speed at which the elastic element 8 is laid down around the forming drum 50.

This laying speed can be the rotation speed of the forming drum 50. Preferably, should the elastic element 8 be used to make a zero-degree layer of the belt structure 3, the laying speed can be defined by the spiralling speed.

In a first embodiment, the laying speed of the elastic element 8 is known a priori and, in order to perform the processing operations hereinafter described, it is fetched from a suitable storage register provided in the control system.

Alternatively, the laying speed can also be detected in real time, through an auxiliary sensor 101 operatively associated with the forming drum 50.

For a particularly accurate and reliable control, both techniques for determining the laying speed can also be simultaneously used.

Then a second parameter P2 is determined which is representative of a percent elongation to apply to the elastic element 8. Preferably, to determine the second parameter P2, a tension 202a which must be applied to the elastic element 8 is first determined; then the second parameter P2 is calculated as a function of this tension 202a.

More particularly, the rotation speed of the control roller 400 is calculated in proportion to the first parameter P1, based on a predetermined coefficient; the latter is a function of said second parameter P2.

Finally, depending on the first and second parameters P1, P2, the rotation speed of the control roller 400 is adjusted.

Practically, through the above described method, relations describing the deformation of an elastic body under static conditions are applied under dynamic conditions, clearly taking into account the fact that the body (i.e. the elastic element 8) is moving.

In more detail, under static conditions the equations describing the behaviour of an elastic body are the following:

$$\begin{matrix}Relative elongation ɛ = \frac{L - {L}_{0}}{{L}_{0}} & ( i ) \\ Tension of the material σ = \frac{F}{A} & ( ii ) \\ {Hooke}^{′} s law σ = E \cdot ɛ & ( iii )\end{matrix}$$

wherein:
F is the external force applied to the elastic body;
σ is the body tension;
A is the body section defined in a plane orthogonal to the direction along which force F is applied;
ε is the relative elongation;
E is the Young's modulus of the material of which the body is made;
L₀ is the body length in the absence of external stresses;
L is the body length obtained following the elastic strain caused by force F.

More particularly, the Applicant has found that the balance equation of the forces acting on the elastic element 8 in the length defined between the control roller 400 and forming drum 50, except for negligible contributions due to non-ideality of the system is the

T₁r+T₂r+C=0 (iv)

wherein:
T₁ is the tension of the elastic element 8 entering the control roller 400;
T₂ is the tension of the elastic element going out of the control roller 400;
r is the radius of the control roller 400;
C is the torque of the motor acting on the control roller 400.

The Applicant points out that it is therefore possible to control the material tension downstream of the control roller 400 irrespective of all that is upstream. More specifically, from the above equations it results that the speed of the control roller 400 can be linked to the speed of the forming drum 50 and the percent elongation of the elastic element 8 by the following relation:

$${V}_{R} ( t ) = {V}_{T} ( t ) \cdot \frac{100}{100 + All \%} \qquad ( v )$$

wherein:
V_{R}(t) is the speed of the control roller 400;
V_{T}(t) is the speed of the forming drum 50;

All % is the percent elongation of the elastic element 8.

Practically, once the desired tension on the laying surface has been defined, it is drawn the elongation to which the elastic element 8 must be correspondingly submitted, and therefrom, through relation (v), the speed to be imposed to the control roller 400 is determined.

It is possible to see that, in the relation (v), V_{T}(t) represents the first parameter P1, All % represents the second parameter P2, while V_{R}(t) is the rotation speed of the control roller 400 that is suitably adjusted.

In order to make the control of the invention more accurate and reliable, it is provided a step of detecting tension 201a of the elastic element 8 between the control roller 400 and forming drum 50; the rotation speed of the control roller 400 is therefore adjusted also as a function of this detected tension 201a.

More specifically, the detected tension 201a is compared with a pre-set tension 202a, defined as a function of the laying time, and determined through a suitable calculation algorithm or selected from a pre-stored table of values; depending on this comparison, a third parameter P3 is determined, i.e. the corrective percent elongation that is to be applied to the elastic element 8.

Practically, a subtraction can be performed between the detected tension 201a and the pre-set tension 202a, so that the obtained error signal can be employed for feedback adjustment of the rotation of the control roller 400.

More specifically, the error signal enters a proportional and integral-mode controller by which the third parameter P3 is calculated, which is the corrective percent elongation relative to that calculated in the open-loop mode, i.e. without detecting tension 201a. This third parameter P3 therefore co-operate in forming value P2; consequently, once P1 and P2 have been determined, it is possible to calculate the real speed to be imposed to the control roller 400 instant by instant.

FIG. 4 shows the laying profile of an elastic element 8 as practically obtained (solid line) and as established during the planning step (chain line).

It is to be noted that tension of the elastic element—in this case consisting of a plurality of rubberised nylon threads used for a zero-degree spiralling—follows the ideal theoretical course in a very precise manner.

FIG. 3 shows a block diagram of an apparatus 99 in accordance with the present invention, by means of which it is possible to implement the above described control method.

Apparatus 99 first of all comprises a first processing module 100 to determine said parameter P1; as specified above, the first parameter P1 is representative of the laying speed at which the elastic element 8 is positioned around the forming drum 50.

Preferably, the first parameter P1 is representative of the rotation speed of the forming drum 50; in the particular case in which the elastic element 8 is used for making a zero-degree reinforcing layer, the first parameter P1 is advantageously the spiralling speed at which the elastic element 8 is applied.

The first processing module 100 can be merely provided for selection of the first parameter P1 in a pre-stored table; the laying speed in fact is generally known a priori.

In a preferred embodiment, the first processing module 100 comprises an auxiliary sensor 101 to detect said first parameter P1; in particular, the auxiliary sensor 101 can be adapted to detect the rotation speed of the forming drum 50.

Apparatus 99 further comprises a second processing module 200 to determine the second parameter P2; the latter is representative of the percent elongation All % to be applied to the elastic element 8 and, as described above, can be calculated starting from the tension that must be applied to the elastic element 8 itself.

Apparatus 99 further comprises said control roller 400. The control roller 400 has a radially external surface 400a that is at least partly in engagement with the elastic element 8 so as to control tension of the latter.

Apparatus 99 also comprises an adjusting module 300 operatively associated with the control roller 400 to adjust the rotation speed of the latter, depending on the first and second parameters P1, P2. In particular, the adjusting module 300 determines the rotation speed of the control roller 400 in proportion to the first parameter P1, based on a predetermined coefficient, the latter being preferably a function of the second parameter P2.

In summary, the relation according to which the rotation speed of the control roller 400 is adjusted is the following:

$${V}_{R} ( t ) = {V}_{T} ( t ) \cdot \frac{100}{100 + All \%}$$

wherein:
V_{R}(t) is the speed of the control roller;
V_{T}(t) is the rotation speed of the forming drum 50 (first parameter P1);
All % is the percent elongation to which the elastic element 8 is to be submitted (second parameter P2).

Preferably, apparatus 99 also comprises a main sensor 201 to detect tension 201a of the elastic element 8 between control roller 400 and forming drum 50.

The adjusting module 300 is operatively associated with said main sensor 201, to adjust the rotation speed of the control roller 400 as a function of the detected tension 201a.

More particularly, apparatus 99 can be provided with a comparing module 203, operatively associated with the main sensor 201, to compare the detected tension 201a with a pre-set tension 202a defined as a function of the laying time, the same pre-set tension 202a being preferably determined by a suitable calculation or selection module 202.

The comparing module 203 is also associated with the second processing module 200, so that the third parameter P3, and consequently P2, can be calculated as a function of said comparison. In this way a further feedback control on the tension of the elastic element 8 is obtained.

In fact, this tension has been already set to acceptable values due to adjustment in the open-loop mode, depending on the percent elongation All % and the rotation speed of the control roller 400.

By virtue of the further control on the real tension applied to the elastic element 8, and the comparison with the theoretical value calculated a priori, it is possible to refine the accuracy of the system to a greater extent and make the latter still more reliable.

As above described, in the preferred embodiment the elastic element 8 is used for manufacture of a zero-degree reinforcing layer for the belt structure 3 and is laid down on the forming drum 50 (that in the case in point is an auxiliary drum or a shaping drum) in the so-called spiralling step.

In this particular case, the first parameter P1, i.e. the laying speed of the elastic element 8, can be defined by the spiralling speed.

1-29. (canceled)

30. A method of laying down at least one elastic element in a process for producing tyres for vehicles, comprising the following steps:
determining a first parameter representative of a laying speed at which at least one elastic element is laid down around a forming drum for a tyre;
determining a second parameter representative of a percent elongation to be applied to said elastic element;
adjusting as a function of said first and second parameters, a rotation speed of a control roller positioned upstream of said forming drum and having a radially external surface at least partly in engagement with said elastic element to control a laying profile of said at least one elastic element.

31. The method as claimed in claim 30, wherein the step of determining said second parameter comprises the following sub-steps:
determining a pre-set tension to be applied to said elastic element as a function of laying time; and
calculating said second parameter as a function of said pre-set tension.

32. The method as claimed in claim 30, wherein the rotation speed of said control roller is calculated in proportion to said first parameter, based on a predetermined coefficient.

33. The method as claimed in claim 32, wherein said predetermined coefficient is a function of said second parameter.

34. The method as claimed in claim 30, further comprising the following steps:
detecting a tension of said elastic element between said control roller and forming drum; and
adjusting the rotation speed of said control roller also as a function of said detected tension.

35. The method as claimed in claim 34, further comprising the following steps:
comparing said detected tension with a pre-set tension determined as a function of the laying time;
determining a third parameter as a function of said comparison; and
determining said second parameter as a function of said third parameter.

36. The method as claimed in claim 30, wherein the step of determining said first parameter comprises a sub-step of detecting laying speed.

37. The method as claimed in claim 30, wherein said elastic element is laid down around said forming drum during a zero-degree spiralling step.

38. The method as claimed in claim 37, wherein said first parameter is representative of a spiralling speed at which said elastic element is wound around said forming drum.

39. A process for producing tyres for vehicles, comprising at least the steps of:
making a carcass structure;
associating said carcass structure with a belt structure; and
associating a tread band with said belt structure at a radially external position, wherein any of said steps comprises:
laying down at least one elastic element at a position radially external to a forming drum by carrying out the following sub-steps:
determining a first parameter representative of a laying speed at which said at least one elastic element is laid down around said forming drum;
determining a second parameter representative of a percent elongation to be applied to said elastic element; and
adjusting as a function of said first and second parameters, a rotation speed of a control roller positioned upstream of said forming drum and having a radially external surface at least partly in engagement with said elastic element to control a laying profile of said at least one elastic element.

40. The process as claimed in claim 39, wherein the sub-step of determining said second parameter comprises:
determining a pre-set tension to be applied to said elastic element, as a function of laying time; and
calculating said second parameter as a function of said pre-set tension.

41. The process as claimed in claim 39, wherein the rotation speed of said control roller is calculated in proportion to said first parameter, based on a predetermined coefficient.

42. The process as claimed in claim 41, wherein said predetermined coefficient is a function of said second parameter.

43. The process as claimed in claim 39, further comprising the following steps:
detecting a tension of said elastic element between said control roller and forming drum; and
adjusting the rotation speed of said control roller also as a function of said detected tension.

44. The process as claimed in claim 43, further comprising the following steps:
comparing said detected tension with a pre-set tension defined as a function of laying time;
determining a third parameter as a function of said comparison; and
determining said second parameter as a function of said third parameter.

45. The process as claimed in claim 39, wherein the step of determining said first parameter comprises a sub-step of detecting said laying speed.

46. The process as claimed in claim 39, wherein during the step of making said belt structure, said elastic element is laid down around said forming drum.

47. The process as claimed in claim 46, wherein said elastic element is laid down around said forming drum through a zero-degree spiralling step.

48. The process as claimed in claim 39, wherein:
said carcass structure is made on a main drum; and
said belt structure is made on an auxiliary drum defined by said forming drum.

49. The process as claimed in claim 39, wherein said forming drum is a substantially toroidal shaping drum.

50. An apparatus for laying down at least one elastic element in a process for producing tyres for vehicles, comprising:
a first processing module for determining a first parameter representative of a laying speed at which at least one elastic element is laid down around a forming drum;
a second processing module for determining a second parameter representative of a percent elongation to be applied to said elastic element;
a control roller positioned upstream of said forming drum and having a radially external surface at least partly in engagement with said elastic element; and
an adjusting module operatively associated with said control roller for adjusting, as a function of said first and second parameters, a rotation speed of said control roller for controlling a laying profile of said at least one elastic element.

51. The apparatus as claimed in claim 50, wherein said second processing module calculates said second parameter depending on a pre-set tension to be applied to said elastic element which is defined as a function of laying time.

52. The apparatus as claimed in claim 50, wherein said adjusting module determines the rotation speed of said control roller in proportion to said first parameter, based on a predetermined coefficient.

53. The apparatus as claimed in claim 52, wherein said predetermined coefficient is a function of said second parameter.

54. The apparatus as claimed in claim 50, further comprising:
a main sensor to detect a tension of said elastic element between said control roller and forming drum,
said adjusting module being operatively associated with said main sensor for adjusting the rotation speed of said control roller also as a function of said detected tension.

55. The apparatus as claimed in claim 54, further comprising:
a comparing module operatively associated with said main sensor to compare said detected tension with a pre-set tension defined as a function of laying time and determined by a calculation or selection module,
said second processing module being operatively associated with said comparing module for determining a third parameter as a function of said comparison,
said second processing module determining said second parameter as a function of said third parameter.

56. The apparatus as claimed in claim 50, wherein said first processing module comprises an auxiliary sensor for detecting said laying speed.

57. The apparatus as claimed in claim 50, wherein said elastic element is laid down around said forming drum in a zero-degree spiralling step.

58. The apparatus as claimed in claim 57, wherein said first parameter is representative of a spiraling speed at which said elastic element is wound around said forming drum.
